(19) United States
(12) Patent Application Publication
(10) Pub. No.: US 2009/0019539 A1
(43) Pub. Date: Jan. 15, 2009

(54) METHOD AND SYSTEM FOR WIRELESS COMMUNICATIONS CHARACTERIZED BY IEEE 802.11W AND RELATED PROTOCOLS

(75) Inventors: Murthy Jonnalagadda, Pune (IN); Deepak Gupta, Pune (IN)

Correspondence Address: AIRTIGHT NETWORKS, 339 N. BERNARDO AVENUE, SUITE 200, MOUNTAIN VIEW, CA, 94043, US

(73) Assignee: AIRTIGHT NETWORKS, INC., Mountain View, CA (US)

(21) Appl. No.: 11/836,805

(22) Filed: Aug. 10, 2007

Related U.S. Application Data
(63) Continuation-in-part of application No. 11/775,869, filed on Jul. 11, 2007.

(51) Int. Cl. G06F 9/00

(52) U.S. Cl. 726/14

(57) ABSTRACT

A method for protecting wireless communications from denial of service attacks is provided. The method comprises establishing a first wireless connection between an access point device and a client device. The method also comprises receiving at the access point device a request for establishing a second wireless connection between the access point device and the client device while a state of the first wireless connection being an established state at an access point device side endpoint. The method comprises verifying whether the first wireless connection is in the established state at the client device side endpoint.

### CROSS-REFERENCES TO RELATED APPLICATIONS

This present application is a continuation in part of the U.S. application Ser. No. 11/775,869, entitled “Method and System for Prevention of Unauthorized Communication over IEEE 802.11w and Related Wireless Protocols”, filed on Jul. 11, 2007; commonly assigned and herein incorporated by reference for all purposes.

### BACKGROUND OF THE INVENTION

Computer systems have proliferated from academic and specialized science applications to day-to-day business, commerce, information distribution and home applications. Such systems can include personal computers (PCs) to large mainframe and server class computers. Powerful mainframe and server class computers run specialized applications for banks, small and large companies, e-commerce vendors, and governments. Personal computers can be found in many offices, homes, and even local coffee shops.

The computer systems located within a specific local geographic region (e.g., an office, building floor, building, home, or any other defined indoor and/or outdoor geographic region) are typically interconnected using a Local Area Network (LAN)(e.g., the Ethernet). The LANs, in turn, can be interconnected with each other using a Wide Area Network (WAN)(e.g., the Internet). A conventional LAN can be deployed using an Ethernet-based infrastructure comprising cables, hubs switches, and other elements.

Connection ports (e.g., Ethernet ports) can be used to couple multiple computer systems to the LAN. For example, a user can connect to the LAN by physically attaching a computing device (e.g., a laptop, desktop, or handheld computer) to one of the connection ports using physical wires or cables. Other types of computer systems, such as database computers, server computers, routers, and Internet gateways, can be connected to the LAN in a similar manner. Once physically connected to the LAN, a variety of services can be accessed and/or provided by these computers (e.g., file transfer, remote login, email, WWW, database access, and voice over IP).

Using recent (and increasingly popular) wireless technologies, users can now be wirelessly connected to the computer network. Thus, wireless communication can provide wireless access to a LAN in the office, home, public hot-spot, and other geographical locations. The IEEE 802.11 family of standards (also called Wireless Local Area Network, WLAN or WiFi) are popular for such wireless communication. In WiFi, the 802.11b standard provides for wireless connectivity at speeds up to 11 Mbps in the 2.4 GHz radio frequency spectrum; the 802.11g standard provides for even faster connectivity up to about 54 Mbps in the 2.4 GHz radio frequency spectrum; and the 802.11a standard provides for wireless connectivity at speeds up to about 54 Mbps in the 5 GHz radio frequency spectrum. Wireless communication standards that offer even higher data rates such AS 802.11n and/or operate in different frequency spectrums such as 802.16 are also possible.

Advantageously, WiFi can facilitate a quick and effective way of providing wireless extension to existing LAN. To provide this wireless extension, one or more WiFi access points (APs) can connect to the connection ports either directly or through intermediate equipment, such as WiFi switch. After an AP is connected to a connection port, a user can access the LAN using a device (called a “station” or a “client”) equipped with WiFi radio. Examples of the devices equipped with WiFi radio include but not limited to laptop computers, personal digital assistants (PDAs), handheld scanners, fixed computers etc. The station can wirelessly communicate with the AP and the AP can transfer information between wired and wireless portions of the LAN.

Certain limitations also exist with WiFi. These limitations can be exploited to launch denial of service (DOS) attacks on the wireless network. For example, via DOS attacks, one or more legitimate wireless clients can be prevented from wirelessly connecting to the APs. For example, in deauthentication DOS attack, an attacker can prevent the legitimate wireless client from wirelessly connecting to the AP by repeatedly disrupting the wireless connection between the client and the AP by repeatedly transmitting spoofed deauthentications. This can result in wireless network unavailability. Since wireless signals can penetrate physical structures such as walls of the building, the DOS attacks can also be launched from outside of the premises of operation of the LAN. Therefore a need arises to improve security of wireless computer networks.

### BRIEF SUMMARY OF THE INVENTION

According to the present invention, techniques directed to wireless computer networking are provided. More particularly, the present invention provides methods and systems for enhancing security of wireless networking environments characterized by the IEEE 802.11w and related protocols, and their variants. In a specific embodiment, the present invention provides methods and systems for protecting wireless communications characterized by 802.11w and related protocols from certain denial of service attacks which also the present applicants have discovered.

According to an embodiment of the present invention, a method is provided for protecting wireless communications from denial of service attacks. The method includes establishing a first wireless connection between an access point device and a client device. An access point device side endpoint and a client device side endpoint are associated with the first wireless connection. Moreover, the establishing at least results in a state of the first wireless connection being an established state at each of the access point device side endpoint and the client device side endpoint. The method includes receiving at the access point device a request for establishing a second wireless connection between the access point device and the client device. Moreover, the request is received while the state of the first wireless connection being the established state at the access point device side endpoint. The method also includes creating an access point device side endpoint for the second wireless connection between the access point device and the client device, subsequent to the receiving the request. Moreover the access point device side endpoint for the second wireless connection is created while the first wireless connection is in the established state at the access point device side endpoint. The method includes verifying whether the first wireless connection is in the established state at the client device side endpoint subsequent to the receiving the request for establishing the second wireless connection at the access point device.

According to an alternative embodiment of the present invention, a wireless access point system is provided for protecting wireless communications from denial of service attacks. The system comprises a memory module comprising one or more electronic memory devices. The memory module stores computer code. The system also comprises a processing module comprising one or more micro processing devices. The processing module is for executing the computer code. The system comprises one or more radio transceiver modules. Moreover, the computer code is adapted to establish a first wireless connection with a client device using at least one of the one or more radio transceiver modules. An access point side endpoint and a client side endpoint are associated with the first wireless connection. The establishing is to also result in a state of the first wireless connection being an established state at each of the access point side endpoint and the client side endpoint. The computer code is also adapted to receive using at least one of the one or more radio transceiver modules a request for establishing a second wireless connection with the client device. Moreover, the request is to be received while the state of the first wireless connection being the established state at the access point side endpoint. The computer code is adapted to create an access point side endpoint for the second wireless connection with the client device, subsequent to the receiving the request. Moreover, the access point side endpoint for the second wireless connection is to be created while the first wireless connection is in the established state at the access point side endpoint. The computer code is also adapted to verify whether the first wireless connection is in the established state at the client side endpoint subsequent to the receiving the request for establishing the second wireless connection.

According to yet an alternative embodiment of the present invention, a method for protecting wireless communications from denial of service attacks is provided. The method includes establishing a first wireless connection between an access point device and a client device. An access point device side endpoint and a client device side endpoint are associated with the first wireless connection. Moreover, the establishing at least results in a state of the first wireless connection being an established state at each of the access point device side endpoint and the client device side endpoint. The method includes receiving at the access point device a request for establishing a second wireless connection between the access point device and the client device. Moreover, the request is received while the state of the first wireless connection being the established state at the access point device side endpoint. The method also includes verifying that the first wireless connection is in the established state at the client device side endpoint subsequent to the receiving at the access point device the request for establishing the second wireless connection. The method includes discarding the request for establishing the second wireless connection subsequent to the verifying.

According to a further alternative embodiment of the present invention, a method is provided for protecting wireless communications from denial of service attacks. The method comprises establishing a first wireless connection between an access point device and a client device. An access point device side endpoint and a client device side endpoint are associated with the first wireless connection. Moreover, the establishing at least results in a state of the first wireless connection being an established state at each of the access point device side endpoint and the client device side endpoint. The method includes receiving at the access point device a request for establishing a second wireless connection between the access point device and the client device. Moreover, the request is received while the state of the first wireless connection being the established state at the access point device side endpoint. The method also includes verifying that the first wireless connection is not in the established state at the client device side endpoint subsequent to the receiving at the access point device the request for establishing the second wireless connection. The method includes terminating the access point device side endpoint for the first wireless connection subsequent to the verifying and creating an access point device side endpoint for the second wireless connection subsequent to the verifying.

According to an embodiment of the present invention, a wireless access point system is provided for protecting wireless communications from denial of service attacks. The system comprises a memory module comprising one or more electronic memory devices. The memory module stores computer code. The system also comprises a processing module comprising one or more micro processing devices. The processing module is to execute the computer code. The system comprises one or more radio transceiver modules. Moreover, the computer code is adapted to establish a first wireless connection with a client device using at least one of the one or more radio transceiver modules. An access point side endpoint and a client side endpoint are associated with the first wireless connection. The establishing is to also result in a state of the first wireless connection being an established state at each of the access point side endpoint and the client side endpoint. The computer code is also adapted to receive using at least one of the one or more radio transceiver modules a request for establishing a second wireless connection with the client device. Moreover, the request is to be received while the state of the first wireless connection being the established state at the access point side endpoint. The computer code is adapted to verify that the first wireless connection is in the established state at the client side endpoint subsequent to the receiving the request for establishing the second wireless connection and to discard the request for establishing the second wireless connection subsequent to the verifying.

According to yet a further embodiment of the present invention, a wireless access point system is provided for protecting wireless communications from denial of service attacks. The system comprises a memory module comprising one or more electronic memory devices. The memory module stores computer code. The system also comprises a processing module comprising one or more micro processing devices. The processing module is to execute the computer code. The system comprises one or more radio transceiver modules. Moreover, the computer code is adapted to establish a first wireless connection with a client device using at least one of the one or more radio transceiver modules. An access point side endpoint and a client side endpoint are associated with the first wireless connection. The establishing is to also result in a state of the first wireless connection being an established state at each of the access point side endpoint and the client side endpoint. The computer code is also adapted to receive using at least one of the one or more radio transceiver modules a request for establishing a second wireless connection with the client device. Moreover, the request is to be received while the state of the first wireless connection being the established state at the access point side endpoint. The computer code is adapted to verify that the first wireless connection is not in the established state at the client side endpoint subsequent to the receiving the request for establishing the second wireless connection. The computer code is also adapted to terminate the access point side endpoint for the first wireless connection subsequent to the verifying and to create an access point side endpoint for the second wireless connection subsequent to the verifying.

Depending upon the embodiment, various advantages and/or benefits can be achieved by practicing the present invention. In an embodiment, the present invention provides for enhancing the security of the wireless networking environments. In an alternative embodiment, the present invention can protect wireless communications characterized by 802.11w and related protocols from certain denial of service attacks. These and other advantages and benefits will be apparent throughout the present specification and more particularly below.

### BRIEF DESCRIPTION OF THE DRAWINGS

FIG. 1 shows an exemplary LAN architecture that can facilitate an environment in which embodiments of the present invention can be practiced.

FIG. 2 shows an exemplary state machine for wireless connection according to an embodiment of the present invention.

FIG. 3 shows an exemplary deadlock of state machines according to an embodiment of the present invention.

FIG. 4 shows an exemplary flowchart of a method for protecting wireless communications from denial of service attacks according to an embodiment of the present invention.

FIG. 5 shows exemplary data structures associated with an endpoint of wireless connection according to an embodiment of the present invention.

FIGS. 6A and 6B show exemplary state machines for wireless connections according to an embodiment of the present invention.

FIG. 7 is an exemplary schematic diagram of a transceiver subsystem according to an embodiment of the present invention.

FIG. 8 shows an exemplary flowchart of a method for verifying whether a wireless connection is in an established state at a client device side endpoint according to an embodiment of the present invention.

FIG. 9 shows an exemplary flowchart of a method for verifying whether a wireless connection is in an established state at a client device side endpoint according to an alternative embodiment of the present invention.

FIG. 10 shows an exemplary flowchart of a method for protecting wireless communications from denial of service attacks according to an alternative embodiment of the present invention.

### DETAILED DESCRIPTION OF SPECIFIC EMBODIMENTS

According to the present invention, techniques for wireless computer networking are provided. The present invention provides methods and systems for improving security of wireless computer networks. More particularly, the present invention provides methods and systems for enhancing security of wireless networking environments characterized by the IEEE 802.11w and related protocols, and their variants. In a specific embodiment, the present invention provides methods and systems for protecting wireless communications characterized by 802.11w and related protocols from certain denial of service attacks.

Using recent (and increasingly popular) wireless technologies, wireless access to the local area networks (LANs) in the offices, homes, public hot-spots, and other geographical locations can be provided. The IEEE 802.11 family of standards (also called Wireless Local Area Network, WLAN or WiFi) are popular for such wireless communication. In WiFi, the 802.11b standard provides for wireless connectivity at speeds up to 11 Mbps in the 2.4 GHz radio frequency spectrum; the 802.11g standard provides for even faster connectivity up to about 54 Mbps in the 2.4 GHz radio frequency spectrum; and the 802.11a standard provides for wireless connectivity at speeds up to about 54 Mbps in the 5 GHz radio frequency spectrum. Wireless communication standards that offer even higher data rates such AS 802.11n and/or operate in different frequency spectrums such as 802.16 are also possible.

Advantageously, WiFi can facilitate a quick and effective way of providing wireless extension to existing LAN. To provide this wireless extension, one or more WiFi access points (APs) can connect to the connection ports either directly or through intermediate equipment, such as WiFi switch. After an AP is connected to a connection port, a user can access the LAN using a device (called a “station” or a “client”) equipped with WiFi radio. Examples of the devices equipped with WiFi radio include but not limited to laptop computers, personal digital assistants (PDAs), handheld scanners, fixed computers etc. The station can wirelessly communicate with the AP and the AP can transfer information between wired and wireless portions of the LAN.

Certain limitations also exist with WiFi. These limitations can be exploited to launch denial of service (DOS) attacks on the wireless network. For example, via DOS attacks, one or more legitimate wireless clients can be blocked from wirelessly connecting to the APs. This can result in wireless network unavailability. Since wireless signals can penetrate physical structures such as walls of the building, the DOS attacks can also be launched from outside of the premises of operation of the LAN. Therefore a need arises to improve security of wireless computer networks.

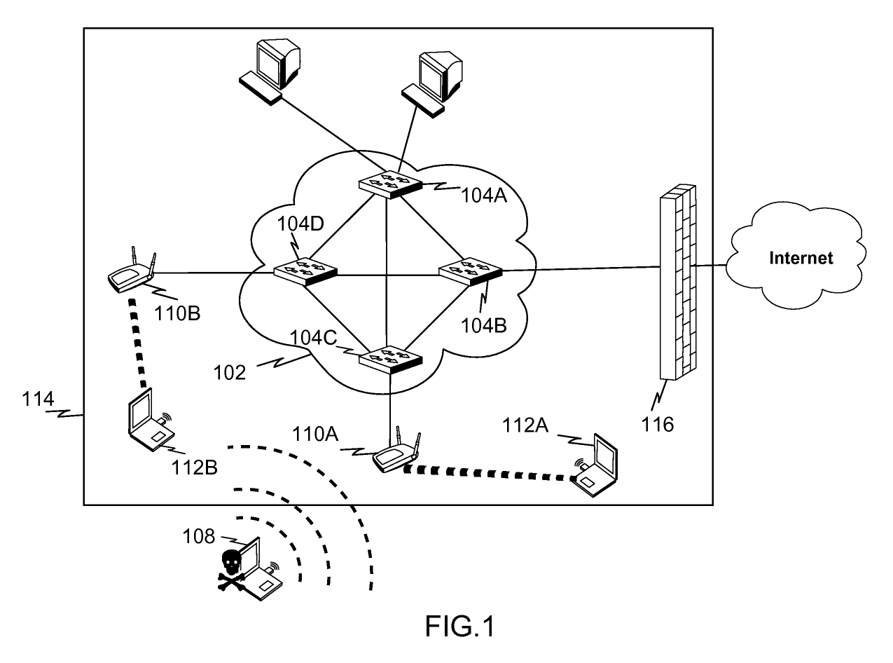

FIG. 1 illustrates an exemplary local area network (LAN) of computing systems that can facilitate an environment for embodiments of the present invention to be practiced. This diagram is merely an example which should not unduly limit the scope of the claims herein. As shown, a core transmission infrastructure 102 of the LAN can include various transmission components, e.g., hubs, switches, and routers (104A-104D), interconnected using wires. The LAN core 102 can be connected to the Internet through a firewall (106). In a typical deployment, the LAN core 102 comprises one or more network segments. In an embodiment, a network segment can be an IP “subnetwork” (called “subnet”). Each subnet can be identified by a network number (e.g., IP number and subnet mask) and a plurality of subnets are interconnected using router devices. In an embodiment, a network segment can be a VLAN (Virtual LAN). Notably, one or more of the network segments can be geographically distributed (e.g., in offices of a company in different geographic locations). The geographically distributed segments can be interconnected via virtual private network (VPN).

In this embodiment, a wireless extension of the LAN core 102 is also provided. For example, one or more authorized APs 110 (e.g., 110A, 110B etc.) can be connected to the LAN core 102. In this configuration, authorized computing devices 112 (e.g., 112A, 112B etc.) such as desktop computers, laptop computers, handheld computers, PDAs, etc. equipped with radio communication can wirelessly connect to LAN through the authorized APs 110. Notably, authorized APs connected to the LAN provide wireless connection points on the LAN. Note that the Institute of Electrical and Electronics Engineers (IEEE) 802.11 family of standards such as 802.11a,b,g,n,i,w etc.(referred as WLAN or WiFi) or another type of wireless network format (e.g., UWB, WiMax, Bluetooth, etc.) can be used to provide the wireless protocols.

According to certain procedure in the IEEE 802.11 MAC protocol an AP periodically transmits beacon packets (hereafter called “beacons”) to announce its existence. Clients will receive these beacons and connect to the AP. Connection establishment between the client and the AP is facilitated by “authentication” and “association” procedures as described in the IEEE 802.11 MAC protocol, and in some embodiments augmented by the security enhancements such as 802.1x, WPA, IEEE 802.11i, IEEE 802.11w etc. Once a client is connected to the AP, it can utilize the services of the AP to access the LAN, and transmit and/or receive “data” packets. Further, breaking of connection between the AP and the client is facilitated by procedures such as “deauthentication” and “disassociation”. The procedures, the frame formats and other information about the IEEE 802.11 MAC standard can be found in the publication of IEEE titled “Part 11: Wireless LAN Medium Access Control (MAC) and Physical Layer (PHY) Specifications”, 1999 Edition, which is herein incorporated by reference and throughout the present specification.

Certain limitations exist with the deauthentication and disassociation procedures. These limitations can be exploited to inflict denial of service (DOS) attacks on the wireless network. For example, a miscreant or an attacker such as hacker sitting in parking lot or in neighboring premises (e.g., attacker 108) can use deauthentication and/or disassociation against legitimate wireless communication in the LAN and cause disruption to the legitimate wireless communication. As merely an example, in order to disrupt wireless communication between the AP 110B and the client 112B, the attacker 108 can use deauthentication procedure. In a typical deauthentication attack process, the attacker can transmit spoofed deauthentication packets (frames) on the same channel on which the wireless link between the AP and the client operates. For example, the attacker can generate one or more IEEE 802.11 frames with type field set as “management” and subtype field set as “deauthentication”. Moreover the source address field is set to the wireless MAC address of the AP 110B (that is, the attacker spoofs the wireless MAC address of the AP 110B), the destination address field is set to the wireless MAC address of the client 112B (or, to a broadcast address of hexadecimal FF:FF:FF:FF:FF:FF), and the BSSID field set to a value same as that used by the frames transmitted by the AP 110B to the client 112B or vice versa (which usually is the wireless MAC address of the AP). When the client 112B receives this frame, it thinks that the AP 110B (e.g., based on the source MAC address field) wants it to disconnect and the client disconnects from the AP. Alternatively, the source address field can be set to the wireless MAC address of the client 112B (that is, the attacker spoofs the wireless MAC address of the client) and the destination address field can be set to the wireless MAC address of the AP 110B. This results in the AP thinking that the client wants to disconnect and the AP disconnects the client. Thus the attacker can keep the client from connecting to the AP and cause disruption to their wireless communication, for example by sending spoofed deauthentication periodically. More information on deauthentication/disassociation attack can be found throughout the present specification and also in the literature, for example, Bellardo and Savage, “802.11 Denial of Service Attacks: Real Vulnerabilities and Practical Solutions”, 12^{th} USENIX Security Symposium, August 2003; and A. Vladimirov, K. Gavrilenko, and A. Mikhailovsky, “Wi-Foo The secrets of Wireless hacking”, Addison-Wesley, 2004, pp. 123-133.). Notably, the attacker 108 can disrupt legitimate wireless communication even from outside of the premises (e.g., premises 114 such as building, office, campus, home etc.) of the operation of the LAN since the DOS attack can be launched using wireless signals.

The IEEE standardization body has recently provided certain description of a protocol called IEEE 802.11w to make IEEE 802.11 MAC protocol resistant to DOS attacks launched using deauthentication and disassociation procedures. Specifically, the IEEE 802.11w protocol specifies that a client will disregard a disconnection request such as deauthentication or disassociation from the AP (i.e., the disconnection request including the AP's MAC address as source address) unless it can validate that it is indeed sent from the AP to which the client station is associated with (connected with). Similarly, the AP will disregard a disconnection request from the client (i.e., the disconnection request including the client's MAC address as source address) unless it can validate that it is indeed sent from the purported client. In this embodiment, disregarding the disconnection request means not disconnecting the wireless link, that is, maintaining the wireless link in a state of being associated in accordance with the IEEE 802.11 MAC protocol even after deauthentication or disassociation frame is received from the peer. In this embodiment, honoring the disconnection request means disconnecting the wireless link, that is, driving the wireless link in a state of being unassociated in accordance with an IEEE 802.11 MAC protocol upon receiving deauthentication or disassociation frame from the peer.

For the validation of the disconnection request (e.g., deauthentication, disassociation etc.), the 802.11w protocol recommends that the disconnection request be authenticated using a shared secret key (e.g., a digital key) that is shared between the AP and the client. That is, the sender of the disconnection request can create a message authentication code on the disconnection request using the shared secret key and the recipient validates this message authentication code using the shared secret key before honoring the request. If the validation fails, it can be an indication that the disconnection request is spoofed (that is, transmitted by some device other than the device associated with the purported source identity in the request) and hence the request is disregarded. If the validation passes, it can be an indication that the disconnection request is non-spoofed (that is, actually transmitted by the device associated with the purported source identity in the request) and hence the request is honored. The 802.11w protocol can resist DOS attacks launched using deauthentication and disassociation procedures. Since the DOS attacker is not expected to have knowledge of the secret key shared between the AP and the client, the DOS attacker cannot create the proper message authentication code on the disconnection request. The attacker's disconnection requests will thus be disregarded by the AP and/or the client.

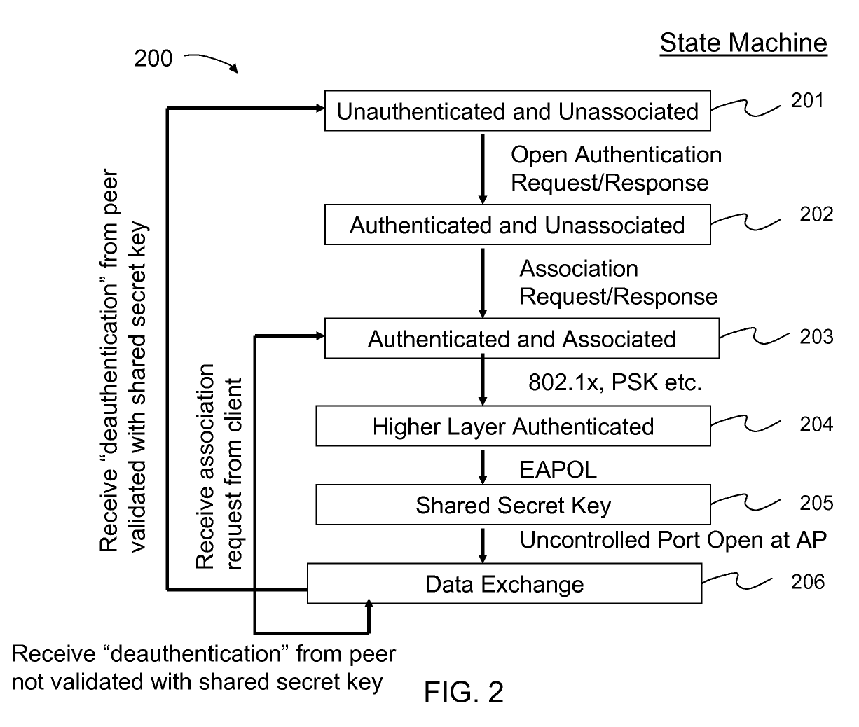

FIG. 2 shows an exemplary connection state machine 200 for a wireless connection between an AP and a client operating according to an IEEE 802.11w protocol. This diagram is merely an example, which should not unduly limit the scope of the claims herein. As shown, connection state machine 200 at each of the AP and the client passes through states 201, 202, 203, 204, 205, and 206. That is, the state machines at the AP and the client pass through these states in a substantially synchronized manner in a preferred embodiment. In state 201 (Unauthenticated and Unassociated), in an embodiment the client discovers APs in its vicinity, for example, using channel scanning and probing. The client and the AP then perform legacy authentication procedure, also called layer 2 authentication, using authentication request (e.g., from the client) and response (e.g., from the AP) message transaction. In this embodiment, the layer 2 authentication can be an open system authentication, that is, no authentication at all. Upon completion of the open system authentication, the state machine at each of the client and the AP enters state 202 (Authenticated and Unassociated). From this state 202, the client and the AP perform association procedure using association request (e.g., from the client) and response (e.g., from the AP) message transaction. At the completion of the association procedure, the state machine at each of the client and the AP enters state 203 (Authenticated and Associated). Additional details on the states 201, 202, and 203 can be found in the IEEE 802.11 MAC standard and throughout the present specification. From the state 203, the client and the AP can perform higher layer authentication using protocols such as 802.1x protocol, PSK (pre-shared key) protocol and like. In this embodiment, the higher layer authentication can be performed using passwords, certificates, smart cards and like. Upon completion of the higher layer authentication, the state machine enters state 204 (Higher Layer Authenticated). More details on the state 204 can be found in the IEEE 802.11i protocol description and throughout the present specification. For example, the IEEE 802.11i protocol description can be found in the publication of the IEEE titled “Part 11: Wireless LAN Medium Access Control (MAC) and Physical Layer (PHY) Specifications: Medium Access Control (MAC) Security Enhancements”, October 2003 Edition, which is herein incorporated by reference.

Additionally, from the state 204 each of the AP and the client acquire secret keys to be used to provide encryption and/or authentication for the frames (packets) exchanged between them. As merely an example EAPOL protocol can be used for acquiring the secret keys. When EAPOL protocol transaction (e.g., EAPOL 4-way handshake) is completed, the state machine at each of the AP and the client enters state 205 (Shared Secret Key). For example, a secret key called DGTK (Disconnect Group Transfer Key) is used for validating (i.e., authenticating) the disconnection requests from the AP to broadcast destination address. In this embodiment, the disconnection requests to the broadcast destination address can be used to instruct all clients to disconnect from the AP. As another example a shared secret key called PTK (Pairwise Transient Key) is used for validating the disconnection requests from the AP to the destination address of the specific client and vice versa. Additional details on state 205 can be found in the IEEE 802.11i protocol description, the IEEE 802.11w protocol description, and throughout the present specification. For example, the IEEE 802.11w protocol description can be found in the publication of IEEE titled “Part 11: Wireless LAN Medium Access Control (MAC) and Physical Layer (PHY) Specifications Amendment—w: Protected Management Frames”, March 2005 Edition, which is herein incorporated by reference. After acquiring the secret keys in state 205, the AP opens data port (called as uncontrolled port) and the state machine enters state 206 (Data Exchange). In the Data Exchange state, the AP can receive data packets from the client and vice versa. As further shown in FIG. 2, if an association request message is received in state 206 from the client, the state machine at the AP can go to the state 203. Alternatively it can go to the state 201 or 202. This transition typically occurs when the client reboots and thus wants to initiate a new connection to the AP. Further, in state 206, if the deauthentication message is received from the peer, in an embodiment, the state machine can go to state 201 only if the deauthentication message can be validated with the secret key (e.g., DGTK, PTK etc.) that is shared between the AP and the client.

Certain limitations, drawbacks and disadvantages exist with the connection state machine just described, which the present applicants have discovered. Notably, the 802.11w protocol including many of its versions, revisions, and proprietary implementations (e.g., one proprietary implementation is called MFP (Management Frame Protection)) operate in a substantially similar fashion as illustrated and described with respect to FIG. 2. Specifically, the present applicants have discovered that even though the connection state machine as in FIG. 2 is resistant to conventional deauthentication and disassociation based DOS attacks, it is still vulnerable to certain other types of DOS attacks. The present applicants have discovered such DOS attacks (which are hereinafter referred to as “deadlock DOS attacks”) which are described more particularly below. The present applicants have also invented techniques to overcome the deadlock DOS attack vulnerability which are described throughout the present invention and more particularly below.

For example, the attacker can disrupt the wireless connection between the AP and the client operating as described in FIG. 2 by transmitting one or more spoofed connection requests. The spoofed connection requests can comprise association request frames formatted in accordance with an IEEE 802.11 MAC protocol. More specifically, a source address in the association request frame is set to a wireless MAC address of the client device (e.g., the attacker device spoofs the client's wireless MAC address) and a destination address in the association request frame is set to a wireless MAC address of the access point device. Alternatively, the spoofed connection requests can comprise layer 2 authentication request, EAPOL start request and so on.

Upon receiving such spoofed connection request (e.g., association request), the state machine in the AP can go to state 203 shown in FIG. 2, that is, to a state of being Authenticated and Associated, but not Higher Level Authenticated. Alternatively it can go to state 201 or 202. This is by design to allow new connection establishment if the client were to reboot and send fresh connection request. In this state, the AP does not accept any frames from client of type data (other than EAP authentication frames) as those frames are not allowed unless the state machine passes the state 205 shown in FIG. 2. Moreover, in the state 203, the AP does not maintain the shared secret keys (e.g., DGTK, PTK etc.) as those are not allowed to be created before state machine passes the state 204. On the contrary, the state machine at the client still remains in the state of 206 (Data Exchange). In the Data Exchange state, the client maintains the shared secret keys and expects the AP to validate any disconnection requests with one or more of these keys. The states of the wireless connection at the AP and the client are thus out of synchronization.

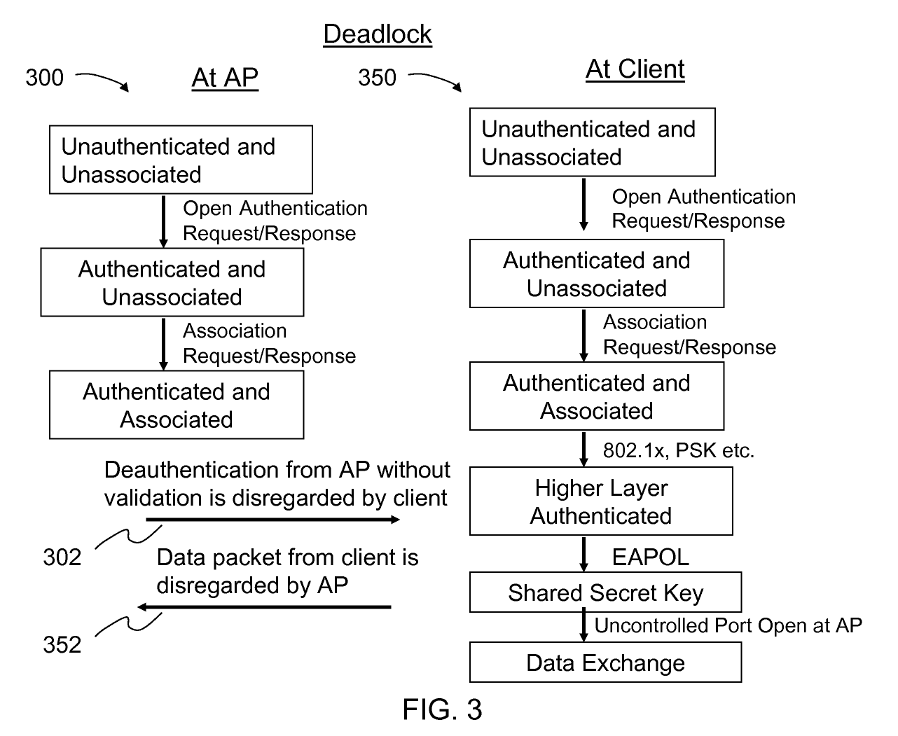

Alternatively, the state machines at the AP and the client are deadlocked as illustrated in FIG. 3. FIG. 3 shows merely an example which should not unduly limit the scope of the claims herein. As shown in FIG. 3, the state machine 300 at the AP goes to a state of being Authenticated and Associated (e.g., state 203 as illustrated in FIG. 2) upon receiving spoofed connection request from the attacker. The state machine 350 at the client remains in a state of Data Exchange (e.g., state 206 as illustrated in FIG. 2). The AP expects the client to initiate/perform/participate in higher level authentication for state machine 300 to evolve beyond the state of Authenticated and Associated. However, the client state machine 350 having already passed the state of being Higher Level Authenticated, the client does not initiate/perform the higher level authentication.

The client can however continue to send data packets (352) to the AP, as the state machine at the client is in the Data Exchange state. The AP disregards these data packets as the AP is not allowed to receive data packets when the state machine at the AP is in state 203. In this embodiment, disregarding the data packet can include dropping the data packet, not forwarding the data packet, not processing at least a portion of the data packet and like. Realizing that the state machine at the client being off-track, the AP can send deauthentication (302) to the client or to a broadcast destination address in an attempt to disconnect the wireless link and re-synchronize the state machines at the AP and the client. However, the client disregards this deauthentication, as in the state 206, the client is not allowed to honor the deauthentication unless it can be validated with the shared secret key. In this embodiment, disregarding the deauthentication can include maintaining the state machine at the client device in the state 206 as shown in FIG. 2. Note the AP does not possess the shared secret key to validate (e.g., authenticate) the deauthentication since the AP's state machine is still at state 203.

The wireless communication over the wireless link between the AP and the client is thus disrupted. This situation can continue until, for example, the client detects that no response is received from the AP to its data packets, infers that the link is broken, and sends fresh association request which can then resynchronize the state machines at the AP and the client. After the link is re-established, another spoofed connection request from the attacker can again put it in a deadlocked condition. By sending a continuous stream of spoofed connection requests, the attacker can keep the link deadlocked for most of the time and thus wireless communication between the AP and the client is disrupted. This is an example of the deadlock DOS attack discovered by the present applicants.

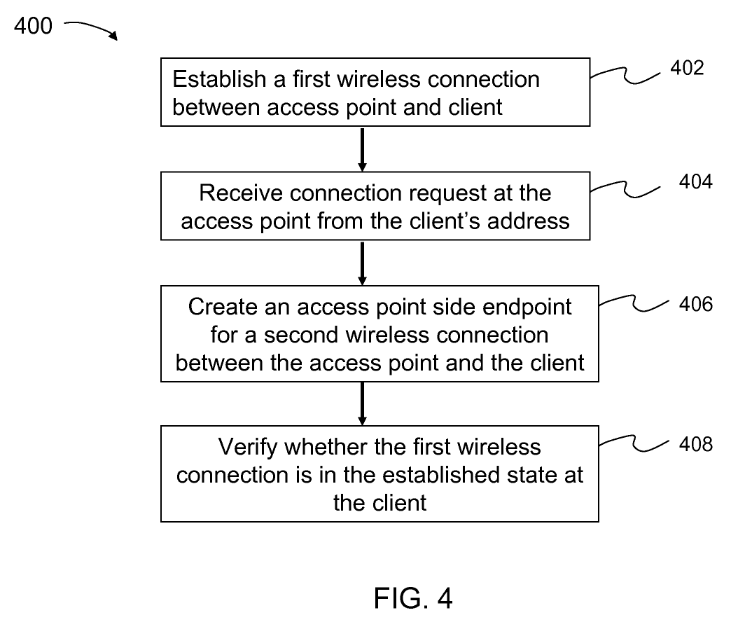

The present applicants have invented techniques to protect against deadlock DOS attacks. According to an embodiment of the present invention a method for protecting wireless communications from denial of service attacks is provided. More particularly, the method for protecting against deadlock DOS attacks is provided. A flowchart for this method 400 is illustrated in FIG. 4. This flowchart is merely an exemplary flowchart which should not unduly limit the scope of the claims herein. According to the method 400, a first wireless connection can be established between an access point device and a client device (step 402). For example, the establishing process can be a connection establishment process operating as per or substantially similar to the connection state machine 200 illustrated and described with respect to FIG. 2 and throughout the present specification.

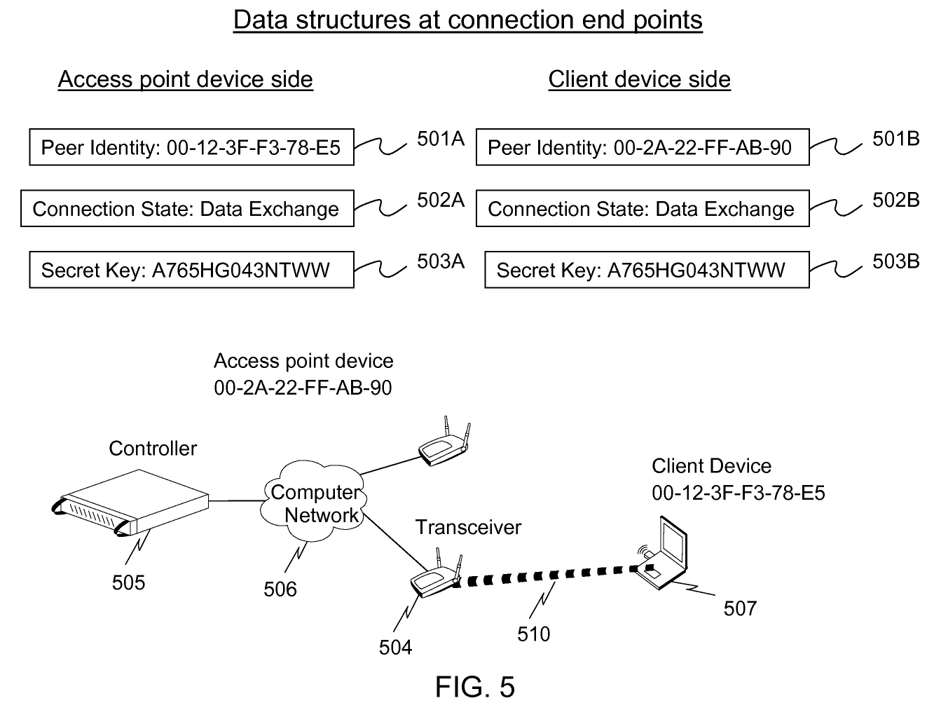

A wireless connection (e.g., established or in process of being established) between the access point device and the client device can have an access point device side endpoint and a client device side endpoint. In an embodiment, one or more data structures can be associated with the endpoint of the wireless connection. Certain exemplary data structures are shown in FIG. 5. The figure shows a wireless connection 510 between an access point device (MAC address: 00-2A-22-FF-AB-90) and a client device 507 (MAC address: 00-12-3F-F3-78-E5). As shown, a data structure 501 can store identity of the peer of the wireless connection. For example, the data structure 501A at the access point device side endpoint can indicate wireless MAC address of the client device as the peer. Similarly, a data structure 501B at the client device side endpoint can indicate wireless MAC address of the access point device as the peer. Another data structure 502 (e.g., 502A on the access point device side and 502B on the client device side) can identify (e.g., track) the state of the wireless connection. In an embodiment, the data structure 502 can track the state of the wireless connection, for example, states 201-206 as illustrated in the state machine 200 of FIG. 2. Yet another data structure 503 can store a secret key negotiated between the access point device and the client device (e.g., negotiated at state 205 of the state machine 200, for example using EAPOL 4-way handshake). Alternatively or in addition, the connection endpoint can also have associated with it software configured to be able to process requests and issue responses associated with the wireless connection.

The establishing the first wireless connection in step 402 of the method 400 at least results in a state of the first wireless connection being an established state (e.g., Data Exchange state 206 in the state machine 200) at each of the access point device side endpoint and the client device side endpoint. As described throughout the present specification and more particularly with respect to the state machine 200, a first secret key is associated with the first wireless connection in the Data Exchange state at each of the access point device side endpoint and the client device side endpoint. For example, the first secret key can include PTK (Pairwise Transient Key) generated using the EAPOL 4-way handshake.

The first secret key can be used to provide cryptographic authentication for the 802.11 frames exchanged between the access point device and the client device. In an embodiment, the cryptographic authentication can be provided via message authentication code (sometimes also referred to as message integrity code (MIC)). For example, a message authentication code is generated by the sender as a function of at least a portion of an 802.11 frame to be sent (e.g., transmitted over wireless medium) and the first secret key. The generated code is included in the transmitted 802.11 frame. The receiver of the frame also generates a message authentication code as a function of (preferably, the same function as that used by the sender) at least a portion of the received 802.11 frame (preferably, the same portion that was used by the sender for the generation of the code) and the first secret key. If the code generated by the receiver matches the code generated by the sender (which is included in the transmitted frame), the cryptographic authentication check is said to have passed on the received frame. If there is no match, the cryptographic authentication check is said to have failed on the received frame.

The first secret key can also be used to provide encryption for the 802.11 frames exchanged between the access point device and the client device. In an embodiment, if the frame that is encrypted by the sender using the first secret key can be properly decrypted (e.g., substantially conforms to the expected format after decrypting) by the recipient, the cryptographic authentication check is said to have passed on the frame.

Further information on generation and use of the first secret key and other information can be found in the description of the IEEE 802.11i and IEEE 802.11w protocols, and throughout the present specification.

At step 404, the method can receive at the access point device a request for establishing a second wireless connection between the access point device and the client device. For example, the request can comprise an association request including identity of the client device as originator of the request (e.g., wireless MAC address of the client device in the source address field of the connection request). Notably, the request is received while the state of the first wireless connection at the access point device side endpoint being the established state. In this embodiment, the request may be originated by the client device (e.g., after rebooting, loss of connection, handoff etc.), or it may be originated by an attacker device to inflict deadlock DOS attack as illustrated and described with respect to FIG. 3 and throughout the present specification. In an embodiment, the method according the present invention can differentiate between the former and the latter cases as described throughout the present specification and more particularly below. The method can thus protect wireless communications from deadlock DOS attacks.

Upon receiving the request as in step 404, the method can create an access point device side endpoint for a second wireless connection between the access point device and the client device (step 406). For example, this step 406 can include creating data structures such as 501A, 502A, 503A etc. associated with the second wireless connection. Alternatively or in addition, this step 406 can include configuring software on the access point device side to be able to process requests and issue responses associated with the second wireless connection. Yet alternatively, this step can include issuing responses (e.g., association response) to the received request (e.g., association request). For example, the issued response can indicate that the received request has been accepted/granted (e.g., success indication in the association response).

Notably the first wireless connection is in the established state at the access point device side endpoint, while the access point device side endpoint for the second wireless connection is created at step 406. According to certain conventional technique, when the access point device side endpoint for the second wireless connection is created (e.g., upon receiving connection request such as association request from MAC address of the client that is already connected), the access point device side endpoint for the first wireless connection (e.g., earlier established wireless connection for the client from whose MAC address the new connection request is received) is terminated. For example, in an embodiment data structures associated with the first wireless connection are deleted and those associated with the second wireless connection are created (e. g., data structures 501A, 502A, 503A etc.). Alternatively, the data structures associated with the first wireless connection are assigned to the second wireless connection and now store data associated with the second wireless connection. Yet alternatively, the access point device discards any data packets (e.g., 802.11 data frames other than those used for higher layer authentication) received from the client device's address until state of the second wireless connection at the access point device side endpoint reaches Data Exchange state (e.g., state 206).

According to the present invention, the first wireless connection is maintained in the established sate at the access point device side endpoint when the access point device side endpoint for the second wireless connection is created. In an embodiment according to the present invention, the access point device continues to process and accept (e.g., upon passing the cryptographic authentication check using the first secret key) any data packets (e.g., 802.11 data frames even other than those used for higher layer authentication) received from the client device's address, even if the state of the second wireless connection at the access point device side endpoint has not reached Data Exchange state (e.g., state 206). In an embodiment, the access point device uses the first secret key to decrypt the encrypted 802.11 data frames received from the client device's address. In an alternative embodiment, the access point device uses the first secret key to perform cryptographic authentication check on the 802.11 data frames received from the client device's address. Alternatively or in addition, the access point device continues to transmit protected data packets (e.g., 802.11 data frames protected using the first secret key) to the client's address even if the state of the second wireless connection at the access point device side endpoint has not reached Data Exchange state (e.g., state 206). The access point device uses the first secret key to protect (e.g., encrypt and/or provide cryptographic authentication for) the 802.11 data frames transmitted to the client device's address.

The method 400 can also verify at step 408 whether the first wireless connection is in the established state at the client device side endpoint subsequent to the receiving the request for establishing the wireless connection at the access point device. In an embodiment, if the verifying indicates that the first wireless connection is in the established state at the client device side endpoint, it can be inferred that the request received in the step 404 was a spoofed request, e.g., intended to inflict deadlock DOS attack. In this case, the first wireless connection is maintained (e.g., maintained in the Data Exchange state). Thus, the access point device continues to process and accept (e.g., upon passing the authentication check using the first secret key) any data packets (i.e., 802.11 data frames even other than used for higher layer authentication) from the client device's address. The access point device uses the first secret key to decrypt and/or authenticate data packets received from the client device's address. The access point device also continues to transmit protected data packets (e.g., 802.11 data frames protected using the first secret key) to the client device's address. The first secret key is used to encrypt and/or authenticate protected data packets transmitted to the client device's address.

In this embodiment, if the verifying indicates that the first wireless connection is in the established state at the client device side endpoint, the access point device side endpoint for the second wireless connection is terminated. The terminating can include erasing and/or deleting data structures (e.g., 501A, 502A, 503A etc.) associated with the second wireless connection from memory of the access point device. Alternatively or in addition, the terminating can include configuring software associated with the endpoint to cease to respond to messages coming from the client device's address as part of the second wireless connection establishment process. Examples of such messages can be EAPOL start message from the client's address which initiates higher layer authentication, higher layer authentication related messages etc.

Alternatively, in an embodiment, if the verifying indicates that the first wireless connection is not in the established state at the client device side endpoint, it can be inferred that the request received in the step 404 is a legitimate request, e.g., the client indeed intends to initiate the second wireless connection (e.g., because is has lost the first wireless connection due to rebooting, handoff, error etc.). In this case, the first wireless connection is terminated at the access point device side endpoint. For example, the terminating can include deleting or erasing data structures (e.g., 501A, 502A, 503A etc.) associated with the first wireless connection from memory of the access point device. Alternatively or in addition, the terminating can include configuring software associated with the access point device side endpoint to cease to accept data packets (e.g., 802.11 frames permitted to be exchanged in the Data Exchange state) from the client device's address, and/or transmit data packets to the client device's address, for example, until state of the second wireless connection at the access point device side endpoint reaches the Data Exchange state. Yet alternatively or in addition to, the terminating can include discontinuing the use of the first secret key to encrypt, decrypt or authenticate the protected 802.11 frames exchanged between the access point device and the client device.

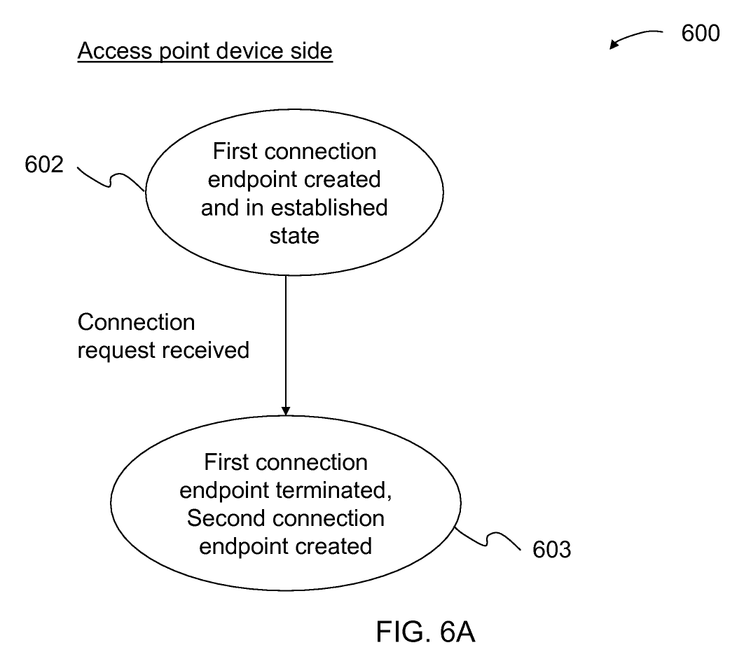

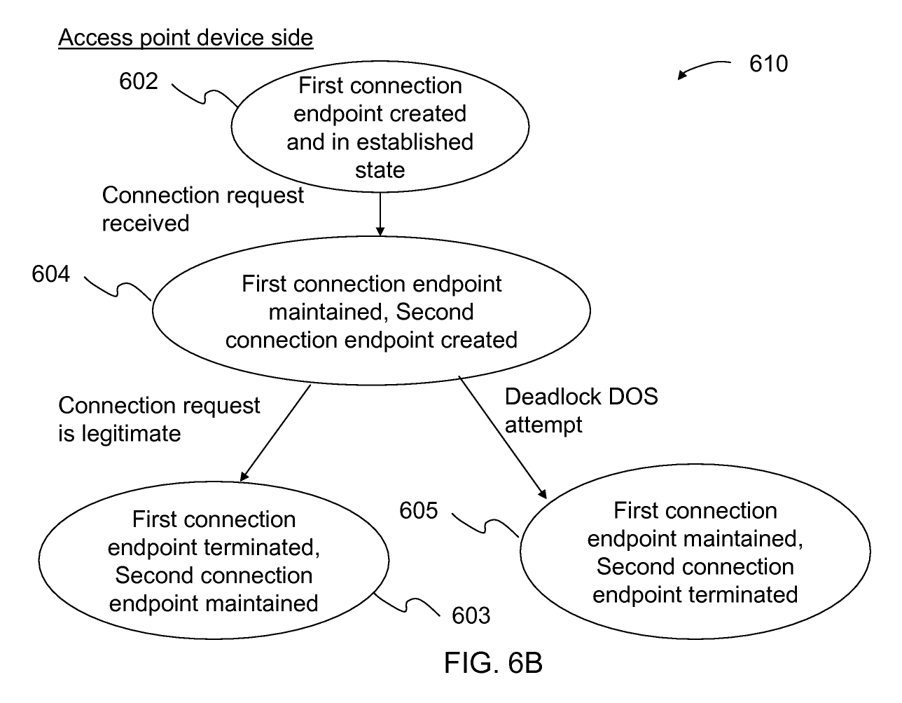

Method according to an embodiment of the present invention is illustrated by way of exemplary state machine diagrams in FIGS. 6A and 6B. These diagrams are merely examples, and should not unduly limit scope of the claims herein. The state diagram 600 in FIG. 6A illustrates certain conventional method. The states illustrated are states at the access point device side endpoint. As shown, upon receiving a connection request from the client's address for which one wireless connection (e.g., first wireless connection) is already established at the access point side endpoint, the state machine transitions from state 602 (First connection endpoint created and in established state) to state 603 (First connection endpoint terminated, Second connection endpoint created). The conventional method is vulnerable to deadlock DOS attacks as illustrated and described with respect to FIG. 3 and throughout the present specification.

The state diagram 610 in FIG. 6B shows certain method according to an embodiment of the present invention. The states illustrated are states at the access point device side endpoint. As shown, upon receiving a connection request from the client's address for which one wireless connection (e.g., first wireless connection) is already established at the access point side endpoint, the state machine transitions from state 602 (First connection endpoint created and in established state) to state 604 (First connection endpoint maintained, Second connection endpoint created). For example, the first connection endpoint can indicate the state as Data Exchange state (e.g., 206 of state machine 200), while the second connection endpoint can indicate the state as Authenticated and Associated (e.g., 203 of state machine 200). In an embodiment, the establishment process for the second wireless connection (e.g., as illustrated by example state machine 200) proceeds after the second wireless connection endpoint is created.

Moreover, if the connection request is detected to be a spoofed connection request (e.g., an attempt to inflict DOS attack), the second connection endpoint is terminated (state 605) and the first wireless connection endpoint is maintained (state 605). On the other hand, if the connection request is determined to be legitimate, the first wireless connection endpoint is terminated (state 603). The method illustrated in the state diagram 610 according to an embodiment of the present invention is advantageously able to avoid deadlock DOS attacks.

In the foregoing description and throughout the present specification, in an embodiment, an access point device can refer to a device including all the functions for forwarding data packets between wired and wireless portions of the LAN. Such an access point device is sometimes called as a “thick” access point or an “autonomous” access point. A thick access point includes one or more radio transceiver modules for transmitting and receiving wireless signals. It can include a wired network interface for connecting to the wired portion of the LAN. The thick access point can include software and hardware for performing 802.11 MAC layer functions such as link management functions (e.g., authentication, association), higher layer authentication functions (e.g., 802.1x authenticator function), wireless data encryption and decryption functions, etc.

Alternatively, in the foregoing description and throughout the present specification, in an embodiment, an access point device can refer to a system comprising a transceiver subsystem (e.g., transceivers 504) and a controller subsystem (e.g., controller 505). In this embodiment, the transceiver subsystem can includes one or more radio transceiver modules for transmitting and receiving wireless signals. The functions such as link management functions (e.g., authentication, association), higher layer authentication functions (e.g., 802.1x authenticator function), and wireless data encryption and decryption functions can be provided in the controller subsystem. This type of configuration of the access point device can sometimes be referred as “tunnel” architecture, “thin” access point architecture, controller architecture etc. For example, the transceiver subsystem receives wireless signals, decodes the wireless signals into 802.11 wireless frames, and transfers the extracted frames to the controller subsystem for further processing and forwarding. The transceiver subsystem receives the 802.11 frames to be transmitted over wireless medium from the controller subsystem, prepares wireless signals for transmitting the frame, and transmits the wireless signals on the wireless medium. The controller subsystem can communicate with one or more transceiver subsystems over a computer network 506 using protocols such as LWAPP (lightweight wireless access point protocol), CAPWAP (control and provisioning of wireless access points) etc. The controller subsystem can communicate with one or more transceiver subsystems.

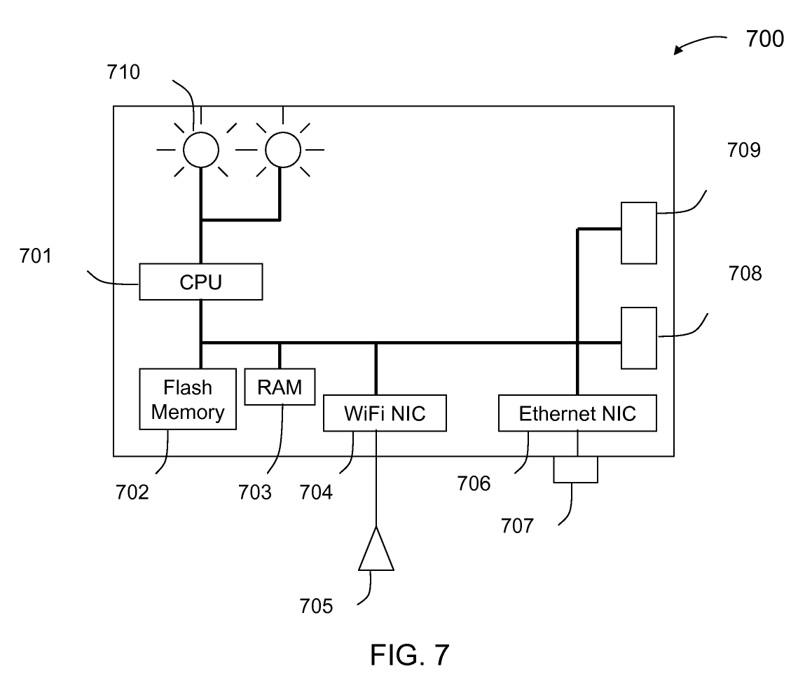

An exemplary hardware diagram of the transceiver subsystem 700 is shown in FIG. 7. This diagram is merely an example, which should not unduly limit the scope of the claims herein. One of ordinary skill in the art would recognize many variations, alternatives, and modifications. As shown, the transceiver subsystem can have a central processing unit (CPU) 701, a flash memory 702 where at least a portion of software for the transceiver subsystem functionality can reside, and a RAM 703 which serves as volatile memory during program execution. The transceiver subsystem can have one or more radio transceiver modules comprising one or more 802.11 wireless network interface cards (NICs) 704 and one or more antennas 705 coupled to the wireless NICs. Each of the wireless NICs 704 can operate in IEEE 802.11a, b, g, n mode, or mixtures thereof. Moreover, the transceiver subsystem can have an Ethernet NIC 706 which performs Ethernet physical and MAC layer functions, an Ethernet jack 707 such as RJ-45 socket coupled to the Ethernet NIC for connecting the transceiver subsystem to wired LAN with optional power over Ethernet or POE. It can have a serial port 708 which can be used to flash/configure/troubleshoot the transceiver subsystem. A power input 709 can also provided. One or more light emitting diodes (LEDs) 710 can be provided to convey visual indications (such as device working properly, error condition, and so on).

In an embodiment the controller subsystem can be provided as a software module in network infrastructure devices such as routers, switches, layer 3 switches, servers etc. In an alternative embodiment, the controller subsystem can be provided in a dedicated appliance comprising one or more processors and at least one wired NIC. Moreover the appliance can comprise one or more memories for storing software for the controller functionality on and off run time.

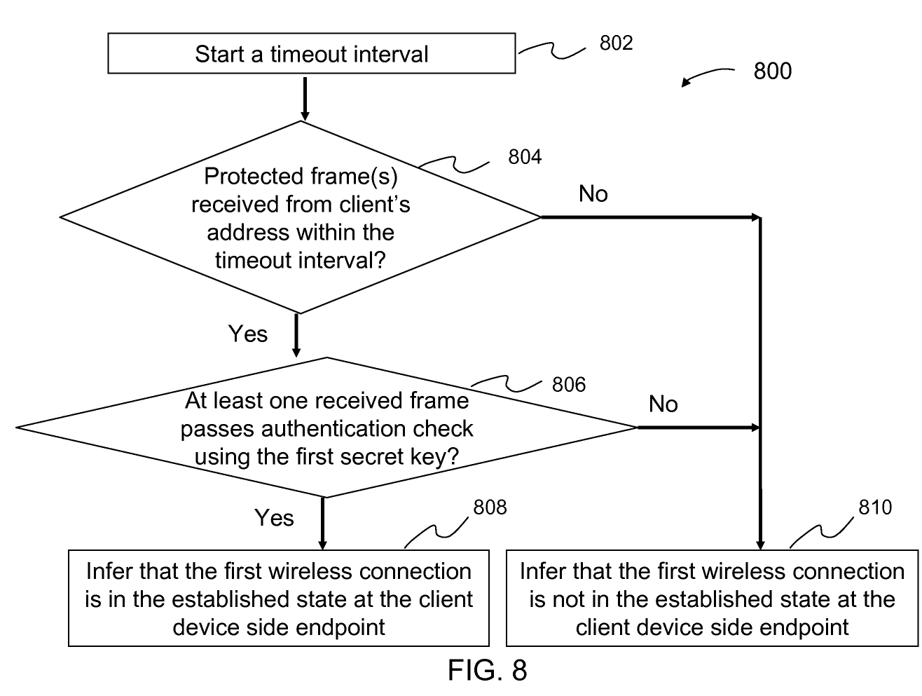

Several alternative embodiments can be used for the verifying step 408 of the method 400 (and also for the verifying step 1006 of the method 1000). An exemplary flowchart for a process 800 for verifying whether the first wireless connection is in the established state at the client device side endpoint according to an embodiment of the present invention for is illustrated in FIG. 8. This flowchart is merely an example and should not unduly limit the scope of the claims herein. As shown, step 802 can start a timeout interval.

Step 804 can determine if at least one protected 802.11 frame is received from the client's address during the timeout interval. In an embodiment, the 802.11 protected frame can refer to a frame which at least facilitates cryptographic authentication check. For example, the cryptographic authentication can be provided using MIC (Message Integrity Code) in accordance with an IEEE 802.11i protocol. Other techniques of providing cryptographic authentication can also be used (e.g., message digest (MD5), SHA etc.). Preferably, the client device transmits the protected 802.11 frames when the state of the wireless connection is the established state at the client device side endpoint. The secret key derived during connection establishment (e.g., in state 205 of the state machine 200, for example, using EAPOL 4-way handshake) can be used for providing cryptographic authentication. For example, the first secret key can be used to provide cryptographic authentication for the protected frame transmitted by the client device over the first wireless connection.

In an embodiment, the protected 802.11 frame can be a data frame transmitted by the client over the wireless connection whose state at the client is the Data Exchange state. As merely an example, such data frame includes a Type field in the 802.11 MAC header being indicative of data (e.g., value of 10 for the Type field bits b3 and b2) and a Type field in the LLC (Logical Link Control) header indicative of the fact that the frame is exchanged in the Data Exchange state (e.g., Type field in the LLC header indicating that the data packet is not an 802.1x packet). As another example, the protected 802.11 frame can be a protected management frame in accordance with an IEEE 802.11w protocol.

If the protected 802.11 frame is received from the client's address during the timeout interval, cryptographic authentication check can be performed on the received frame (step 806). For example, the access point device can check using the first secret key whether the correct value of MIC is found in the received frame. Moreover, in an embodiment, the access point device can decrypt the data frame (e.g., using the first secret key) before or along with verifying the MIC. More details on the cryptographic authentication check can be found in the IEEE 802.11i and 802.11w protocol descriptions, and throughout the present specification.

If the cryptographic authentication check passes (e.g., the MIC is proper, the frame is properly decrypted etc.), the received frame can be inferred to be transmitted by the client device proper and not to be a spoofed one. It can thus be inferred that the first wireless connection is in the established state at the client device side endpoint (step 808).

On the other hand, if no protected frame is received during the timeout interval it can be inferred that the first wireless connection is not in the established state at the client device side endpoint (step 810). Alternatively, if every protected frame received at step 804 fails the authentication check at step 806, it can be inferred that the first wireless connection is not in the established state at the client device side endpoint (step 810).

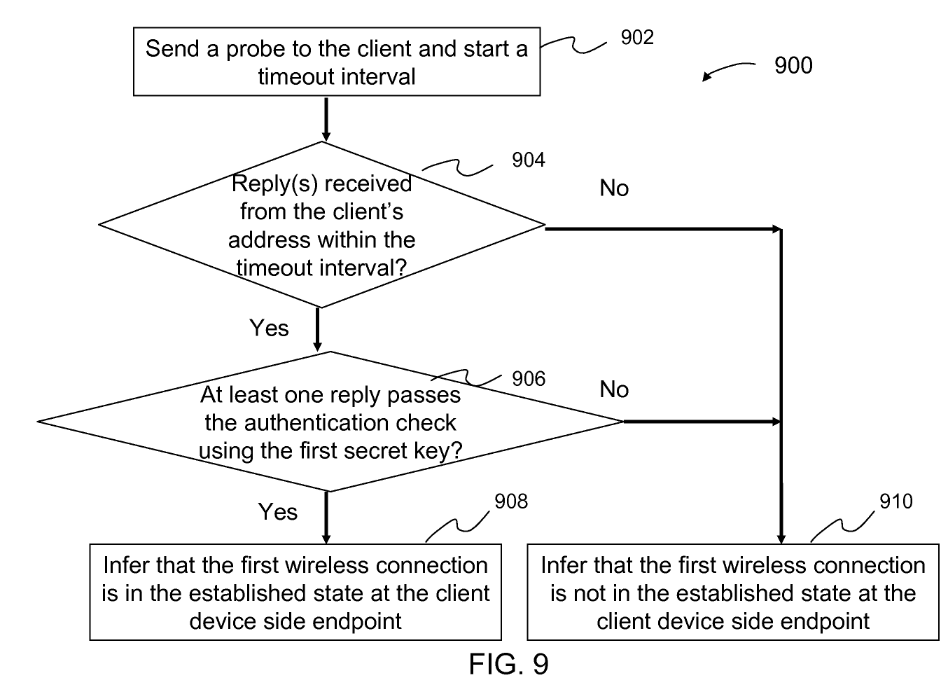

An exemplary flowchart for a process 900 for verifying whether the first wireless connection is in the established state at the client device side endpoint according to an embodiment of the present invention is illustrated in FIG. 9. This flowchart is merely an example and should not unduly limit the scope of the claims herein. As shown, step 902 can send a probe to the client and start a timeout interval. For example, a probe can be a management frame or a data frame. Preferably, cryptographic authentication is provided for the probe using the first secret key. For example, the probe can be a protected data frame or a protected management frame. Preferably, the client device should respond to the probe if the state of the first wireless connection at the client device side endpoint is the established state (e.g., Data Exchange state 206).

Step 904 can determine if at least one reply to the probe is received from the client device's address during the timeout interval. If at least one reply is received from the client device's address during the timeout interval, a cryptographic authentication check can be performed on the received reply, for example, using the first secret key (step 906). For example, a reply can be included in a protected data frame or a protected management frame. If the cryptographic authentication check passes, the received reply can be inferred to be transmitted by the client device proper and not to be a spoofed one. It can thus be inferred that the first wireless connection is in the established state at the client device side endpoint (step 908). On the other hand if no reply is received during the timeout interval it can be inferred that the first wireless connection is not in the established state at the client device side endpoint (step 910). Alternatively, if every reply received at step 904 fails the authentication check at step 906, it can be inferred that the first wireless connection is not in the established state at the client device side endpoint (step 910).

Other alternatives for verifying whether the first wireless connection is in the established state are possible and will be apparent to persons with ordinary skill in the art based upon the teachings of the present specification. As merely an example, an alternative embodiment can include determining whether the connection request is a MAC spoofed request, i.e., determining whether the connection request is transmitted by a device other than the client device even if it includes the client device's wireless MAC address as the originator of the request.

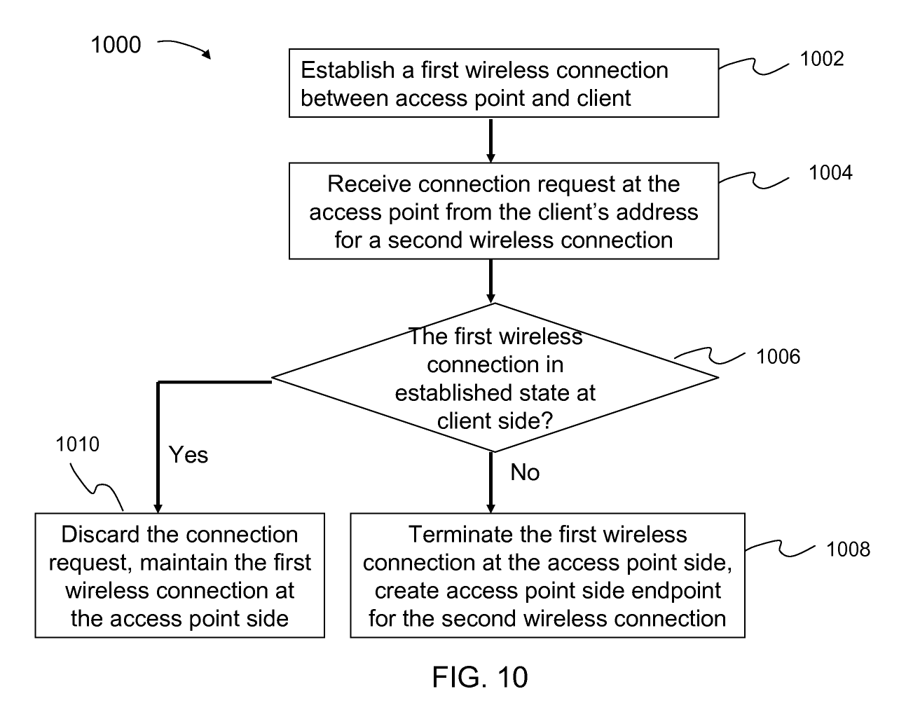

According to an alternative embodiment of the present invention a method is provided for protecting wireless communications from denial of service attacks. A flowchart for this method 1000 is illustrated in FIG. 10. This flowchart is merely an exemplary flowchart which should not unduly limit the scope of the claims herein. According to the method 1000, a first wireless connection can be established between an access point device and a client device (step 1002). For example, the establishing process can be a connection establishment process operating as per or substantially similar to the connection state machine 200 illustrated and described with respect to FIG. 2 and throughout the present specification.

At step 1004, the method can receive at the access point device a request for establishing a second wireless connection between the access point device and the client device. For example, the request can comprise an association request including identity of the client device as originator of the request (e.g., wireless MAC address of the client device in the source address field of the connection request). As another example, the request can comprise a layer 2 authentication request. As yet another example, the request can comprise an EAPOL start request. The layer 2 authentication request or the EAPOL start request can each include identity of the client device as originator of the request (e.g., wireless MAC address of the client device in the source address field of the connection request). Notably, the request is received while the state of the first wireless connection at the access point device side endpoint being the established state. In this embodiment, the request may be originated by the client device (e.g., after rebooting, loss of connection, handoff etc.), or it may be originated by an attacker device to inflict deadlock DOS attack as illustrated and described with respect to FIG. 3 and throughout the present specification. In an embodiment, the method according the present invention can differentiate between the former and the latter cases as described throughout the present specification and more particularly below. The method can thus protect wireless communications from deadlock DOS attacks.

The method can also verify at step 1006 whether the first wireless connection is in the established state at the client device side endpoint subsequent to the receiving the request for establishing the wireless connection at the access point device. In an embodiment, if the verifying indicates that the first wireless connection is in the established state at the client device side endpoint, it can be inferred that the request received in the step 1004 was a spoofed request, e.g., intended to inflict deadlock DOS attack. In this case (step 1010), the access point device side endpoint for the first wireless connection is maintained (e.g., maintained in the Data Exchange state). Moreover, the request for establishing the second wireless connection is discarded. On the other hand, if the verifying indicates that the first wireless connection is not in the established state at the client device side endpoint, it can be inferred that the request received in the step 1004 was a legitimate request, e.g., the client indeed intends to initiate the second wireless connection (e.g., because is has lost the first wireless connection due to rebooting, handoff, error etc.). In this case (step 1008), the first wireless connection is terminated at the access point device side endpoint. Moreover, access point device side endpoint is created for the second wireless connection.

It should be appreciated that the specific steps described in various methods and illustrated in various flowcharts and state machines provide specific processes of protecting wireless communication from DOS attacks according to embodiments of the present invention. Other sequences of steps may also be performed according to alternative embodiments. For example, alternative embodiments of the present invention may perform the steps outlined above in a different order. Moreover, the individual steps may include multiple sub-steps that may be performed in various sequences as appropriate to the individual step. Furthermore, additional steps may be added or removed depending on the particular applications. One of ordinary skill in the art would recognize many variations, modifications, and alternatives based on the teachings of this present specification.

Although specific embodiments of the present invention have been described, it will be understood by persons with ordinary skill in the art that there are other embodiments that are equivalent to the described embodiments. As merely an example, while the specific embodiments have been described for infrastructure mode wireless connection (e.g., wireless connection between AP and client), the techniques of the present invention can also be used for ad hoc wireless connection (e.g., wireless connection between two client devices). As another example, teachings of the present invention can be used for wireless connections operating according to different versions/revisions of the IEEE 802.11w protocol, their proprietary implementations (e.g., Management Frame Protection (MFP)), modifications, or other protocols which operate in a manner substantially similar to the IEEE 802.11w protocol. As yet another example, techniques of the present invention can be used in variety of access point architectures such as thin access point architectures (for example, LWAPP, CAPWAP etc.), thick access point architectures (e.g., standalone access point), and others. As further example, a connection request can include association request, layer 2 authentication request, EAPOL start request. As a further example, different techniques, including but not limited to AES, TKIP (Temporal Key Integrity Protocol), and WEP (Wired Equivalent Privacy), can be used for protecting the 802.11 frames (e.g., for transmitting and receiving). Other alternative embodiments are also possible. Accordingly, it is to be understood that the invention is not to be limited by the specific illustrated embodiments, but only by the scope of the appended claims.

What is claimed is:

1. A method for protecting wireless communications from denial of service attacks, the method comprising:
establishing a first wireless connection between an access point device and a client device, an access point device side endpoint and a client device side endpoint being associated with the first wireless connection, the establishing at least resulting in a state of the first wireless connection being an established state at each of the access point device side endpoint and the client device side endpoint;
receiving at the access point device a request for establishing a second wireless connection between the access point device and the client device while the state of the first wireless connection being the established state at the access point device side endpoint;
creating an access point device side endpoint for the second wireless connection between the access point device and the client device, subsequent to the receiving the request, while the first wireless connection is in the established state at the access point device side endpoint; and
verifying whether the first wireless connection is in the established state at the client device side endpoint subsequent to the receiving the request for establishing the second wireless connection at the access point device.

2. The method of claim 1, and further comprising maintaining the first wireless connection in the established state at the access point device side endpoint if the verifying indicates that the first wireless connection is in the established state at the client device side endpoint.

3. The method of claim 2, and further comprising terminating the access point device side endpoint for the second wireless connection.

4. The method of claim 1, and further comprising terminating the access point device side endpoint for the first wireless connection if the verifying indicates that the first wireless connection is not in the established state at the client device side endpoint.

5. The method of claim 1 wherein a first secret key being associated with the first wireless connection while the first wireless connection is in the established state at the access point device side endpoint, the first secret key being used at least for providing cryptographic authentication for 802.11 frames transferred over the first wireless link.

6. The method of claim 5 wherein the verifying comprising:
receiving a protected 802.11 frame from the client device's address at the access point device subsequent to the receiving the request for establishing the second wireless connection; and
performing a cryptographic authentication check on the protected 802.11 frame using the first secret key associated with the first wireless connection.

7. The method of claim 6, and further comprising:
maintaining the first wireless connection in the established state at the access point device side endpoint; and
terminating the access point device side endpoint for the second wireless connection;
if the cryptographic authentication check passes on the received protected 802.11 frame.

8. The method of claim 1 wherein the verifying comprising transmitting a probe from the access point device to the client device, the transmitting the probe being responsive to the receiving at the access point device the request for establishing the second wireless connection.

9. The method of claim 8 wherein the verifying further comprising receiving a reply from the client device's address at the access point device, the reply being responsive to the probe.

10. The method of claim 9 wherein the verifying further comprising verifying whether the received reply was indeed originated by the client device by performing a cryptographic authentication check on the reply using a first secret key, the first secret key being associated with the first wireless connection while the first wireless connection is in the established state at the access point device side endpoint, the first secret key being used at least for providing cryptographic authentication for 802.11 frames transferred over the first wireless link.

11. The method of claim 10, and further comprising terminating the access point device side endpoint for the second wireless connection if the cryptographic authentication check passes on the reply.

12. The method of claim 8 wherein the verifying further comprising initiating a timeout interval.

13. The method of claim 12, and further comprising terminating the access point device side endpoint for the first wireless connection if a reply is not received from the client device's address responsive to the probe during the timeout interval.

14. The method of claim 1 wherein the verifying comprising:
initiating a timeout interval; and
determining if at least one protected 802.11 frame is received from the client device's address during the timeout interval.

15. The method of claim 14, and further comprising terminating the access point device side endpoint for the first wireless connection if at least one protected 802.11 frame is not received from the client device's address during the timeout interval.

16. The method of claim 1 wherein the verifying comprising determining whether higher layer authentication succeeds at the access point device side endpoint for the second wireless connection.

17. The method of claim 16, and further comprising terminating the access point device side endpoint for the first wireless connection if the determining indicates that the higher layer authentication succeeds at the access point device side endpoint for the second wireless connection.

18. The method of claim 16 wherein the higher layer authentication is provided using at least one selected from the group consisting of PEAP (Protected Extensible Authentication Protocol), TTLS (Tunneled Transport Layer Security) and MSCHAP (Microsoft Challenge Authentication Protocol); and the method further comprising terminating the access point device side endpoint for the second wireless connection if the determining indicates that the higher layer authentication fails at the access point device side endpoint for the second wireless connection.

19. A wireless access point system for protecting wireless communications from denial of service attacks, the system comprising:
a memory module comprising one or more electronic memory devices storing computer code;
a processing module comprising one or more micro processing devices for executing the computer code; and
one or more radio transceiver modules;
wherein the computer code is adapted to:
establish a first wireless connection with a client device using at least one of the one or more radio transceiver modules, an access point side endpoint and a client side endpoint being associated with the first wireless connection, to result in a state of the first wireless connection being an established state at each of the access point side endpoint and the client side endpoint;
receive using at least one of the one or more radio transceiver modules a request for establishing a second wireless connection with the client device while the state of the first wireless connection being the established state at the access point side endpoint;
create an access point side endpoint for the second wireless connection with the client device, subsequent to the receiving the request, while the first wireless connection is in the established state at the access point side endpoint; and
verify whether the first wireless connection is in the established state at the client side endpoint subsequent to the receiving the request for establishing the second wireless connection.

20. The system of claim 19 being provided as a combination of a transceiver subsystem and a controller subsystem.

21. The system of claim 20 wherein at least a portion of the memory module is provided within the transceiver subsystem.

22. The system of claim 20 wherein at least a portion of the memory module is provided within the controller subsystem.

23. The system of claim 20 wherein at least a portion of the processing module is provided within the transceiver subsystem.

24. The system of claim 20 wherein at least a portion of the processing module is provided within the controller subsystem.

25. The system of claim 20 wherein the one or more radio transceiver modules are provided within the transceiver subsystem.

26. The system of claim 19 wherein the computer code is further adapted to maintain the first wireless connection in the established state at the access point side endpoint if the first wireless connection is verified to be in the established state at the client side endpoint.

27. The system of claim 26 wherein the computer code is further adapted to terminate the access point side endpoint for the second wireless connection.

28. The system of claim 19 wherein the computer code is further adapted to terminate the access point side endpoint for the first wireless connection if the first wireless connection is verified not to be in the established state at the client side endpoint.

29. The system of claim 19 wherein the computer code adapted to create the access point side endpoint for the second wireless connection with the client device, subsequent to the receiving the request, while the first wireless connection is in the established state at the access point side endpoint, comprises a computer code adapted to send a response to the request.

30. The system of claim 29 wherein the request includes an association request including the client device's wireless MAC address in a source address field of the association request, and the response to the request includes an association response including the client device's wireless MAC address in a destination address field of the association response.

31. The system of claim 19 wherein the computer code adapted to create the access point side endpoint for the second wireless connection with the client device, subsequent to the receiving the request, while the first wireless connection is in the established state at the access point side endpoint, comprises a computer code adapted to create one or more data structures associated with the second wireless connection at the access point side endpoint.

32. The system of claim 19 wherein the computer code is further adapted to:
receive one or more protected 802.11 frames from the client device's address; and
decrypt the received the one or more protected 802.11 frames using a first secret key, the first secret key being associated with the first wireless connection while the first wireless connection is in the established state at the access point device side endpoint, the first secret key being used at least for providing encryption for 802.11 frames transferred over the first wireless link;
subsequent to the creation of the access point side endpoint for the second wireless connection and prior to conclusion of the verification of whether the first wireless connection is in the established state at the client side endpoint.

33. A method for protecting wireless communications from denial of service attacks, the method comprising:
establishing a first wireless connection between an access point device and a client device, an access point device side endpoint and a client device side endpoint being associated with the first wireless connection, the establishing at least resulting in a state of the first wireless connection being an established state at each of the access point device side endpoint and the client device side endpoint;
receiving at the access point device a request for establishing a second wireless connection between the access point device and the client device while the state of the first wireless connection being the established state at the access point device side endpoint;
verifying that the first wireless connection is in the established state at the client device side endpoint subsequent to the receiving at the access point device the request for establishing the second wireless connection; and
discarding the request for establishing the second wireless connection, the discarding being subsequent to the verifying.

34. The method of claim 33, and further comprising maintaining the state of the first wireless connection in the established state at the access point device side endpoint, subsequent to the verifying.

35. The method of claim 33 wherein the verifying comprising transmitting a probe from the access point device to the client device, the transmitting the probe being responsive to the receiving at the access point device the request for establishing the second wireless connection.

36. The method of claim 35 wherein the verifying further comprising receiving a reply from the client device's address at the access point device, the reply being responsive to the probe.

37. The method of claim 36 wherein the verifying further comprising performing a cryptographic authentication check on the reply using a first secret key, the first secret key being associated with the first wireless connection while the first wireless connection is in the established state at the access point device side endpoint, the first secret key being used at least for providing cryptographic authentication for 802.11 frames transferred over the first wireless link.

38. The method of claim 37 wherein the cryptographic authentication check passes on the reply.

39. The method of claim 33 wherein the verifying comprising:
receiving a protected 802.11 frame from the client device's address at the access point device subsequent to the receiving at the access point device the request for establishing the second wireless connection; and
performing a cryptographic authentication check on the protected 802.11 frame using a first secret key, the first secret key being associated with the first wireless connection while the first wireless connection is in the established state at the access point device side endpoint, the first secret key being used at least for providing cryptographic authentication for 802.11 frames transferred over the first wireless link.

40. The method of claim 39 wherein the cryptographic authentication check passes on the reply.

41. A method for protecting wireless communications from denial of service attacks, the method comprising:
establishing a first wireless connection between an access point device and a client device, an access point device side endpoint and a client device side endpoint being associated with the first wireless connection, the establishing at least resulting in a state of the first wireless connection being an established state at each of the access point device side endpoint and the client device side endpoint;
receiving at the access point device a request for establishing a second wireless connection between the access point device and the client device while the state of the first wireless connection being the established state at the access point device side endpoint;
verifying that the first wireless connection is not in the established state at the client device side endpoint subsequent to the receiving the request at the access point device for establishing the second wireless connection;
terminating the access point device side endpoint for the first wireless connection subsequent to the verifying; and
creating an access point device side endpoint for the second wireless connection subsequent to the verifying.

42. The method of claim 41 wherein the verifying comprising:
transmitting a probe from the access point device to the client device, the transmitting the probe being responsive to the receiving at the access point device the request for establishing the second wireless connection; and
initiating a timeout interval.

43. The method of claim 42 wherein the verifying further comprising determining that a reply is not received from the client device's address at the access point device within the timeout interval, the reply being responsive to the probe.

44. The method of claim 42 wherein the verifying further comprising:
receiving a reply from the client device's address at the access point device within the timeout interval, the reply being responsive to the probe; and
performing a cryptographic authentication check on the reply using a first secret key, the first secret key being associated with the first wireless connection while the first wireless connection is in the established state at the access point device side endpoint, the first secret key being used at least for providing cryptographic authentication for 802.11 frames transferred over the first wireless link.

45. The method of claim 44 wherein the cryptographic authentication check fails on the reply.

46. A wireless access point system for protecting wireless communications from denial of service attacks, the system comprising:
a memory module comprising one or more electronic memory devices storing computer code;
a processing module comprising one or more micro processing devices for executing the computer code; and
one or more radio transceiver modules;
wherein the computer code is adapted to:
establish a first wireless connection with a client device using at least one of the one or more radio transceiver modules, an access point side endpoint and a client side endpoint being associated with the first wireless connection, to result in a state of the first wireless connection being an established state at each of the access point side endpoint and the client side endpoint;
receive using at least one of the one or more radio transceiver modules a request for establishing a second wireless connection with the client device while the state of the first wireless connection being the established state at the access point side endpoint;
verify that the first wireless connection is in the established state at the client side endpoint subsequent to the receiving the request for establishing the second wireless connection; and
discard, subsequent to the verifying, the request for establishing the second wireless connection.

47. The system of claim 46 being provided as a combination of a transceiver subsystem and a controller subsystem.

48. The system of claim 47 wherein at least a portion of the memory module is provided within the transceiver subsystem.

49. The system of claim 47 wherein at least a portion of the memory module is provided within the controller subsystem.

50. The system of claim 47 wherein at least a portion of the processing module is provided within the transceiver subsystem.

51. The system of claim 47 wherein at least a portion of the processing module is provided within the controller subsystem.

52. The system of claim 47 wherein the one or more radio transceiver modules are provided within the transceiver subsystem.

53. A wireless access point system for protecting wireless communications from denial of service attacks, the system comprising:
a memory module comprising one or more electronic memory devices storing computer code;
a processing module comprising one or more micro processing devices for executing the computer code; and
one or more radio transceiver modules;
wherein the computer code is adapted to:
establish a first wireless connection with a client device using at least one of the one or more radio transceiver modules, an access point side endpoint and a client side endpoint being associated with the first wireless connection, to result in a state of the first wireless connection being an established state at each of the access point side endpoint and the client side endpoint;
receive using at least one of the one or more radio transceiver modules a request for establishing a second wireless connection with the client device while the state of the first wireless connection being the established state at the access point side endpoint;
verify that the first wireless connection is not in the established state at the client side endpoint subsequent to the receiving the request for establishing the second wireless connection;
terminate the access point side endpoint for the first wireless connection subsequent to the verifying; and
create an access point side endpoint for the second wireless connection subsequent to the verifying.

54. The system of claim 53 being provided as a combination of a transceiver subsystem and a controller subsystem.

55. The system of claim 53 wherein the computer code adapted to create the access point side endpoint for the second wireless connection with the client device, subsequent to the verifying, comprises a computer code adapted to send a response to the request.

56. The system of claim 55 wherein the request includes an association request including the client device's wireless MAC address in a source address field of the association request, and the response to the request includes an association response including the client device's wireless MAC address in a destination address field of the association response.
